(19) United States
(12) Patent Application Publication
(10) Pub. No.: US 2012/0028691 A1
(43) Pub. Date: Feb. 2, 2012

(54) Case For A Portable Electronic Device

(75) Inventor: Heath D. Koehl, West Frankfort, IL (US)

(73) Assignee: Mr. Heath D. Koehl, West Frankfort, IL (US)

(21) Appl. No.: 12/846,431

(22) Filed: Jul. 29, 2010

(51) Int. Cl. H04W 88/02

(52) U.S. Cl. 455/575.1

(57) ABSTRACT

A case for a mobile telephone generally includes a waterproof exterior material and a thermally insulating interior material lining the exterior material to define a closable interior space in which the mobile telephone can be housed in a watertight and thermally insulated manner.

### BACKGROUND

This disclosure relates generally to cases for portable electronic devices and, more particularly, to waterproof and insulated cases for portable electronic devices.

When an electronic device, such as a mobile telephone, is subjected to cold temperatures (e.g., when a mobile telephone is left in a car or carried on an outdoor excursion during the winter months), the device could be adversely affected functionally and/or structurally (e.g., the user interface could freeze, the battery could lose its charge, and/or moisture could build up on circuitry). Additionally, when a user carries an electronic device into a wet environment (e.g., outside in the rain or on a fishing trip), the device could be exposed to moisture from the environment, which could adversely affect the device functionally and/or structurally.

There is a need for a case that adequately protects an electronic device, such as a mobile telephone, from adverse affects associated with cold temperatures and moisture.

### SUMMARY

In one embodiment, a case for an electronic device such as a mobile telephone generally includes a waterproof exterior material and a thermally insulating interior lining to define a closable interior space in which the electronic device can be housed in a watertight and thermally insulated manner.

In another embodiment, a case for an electronic device generally includes a waterproof body and a flap connected to the body. The body includes a transparent front wall, and the body defines a closable interior space in which the electronic device can be housed in a watertight manner. The flap is configured to be moved between a closed position in which the flap covers the front wall and an open position in which the flap does not cover the front wall such that the electronic device can be at least one of viewed and operated through the front wall.

In yet another embodiment, a case for an electronic device generally includes a body and a flap connected to the body. The body includes a waterproof exterior material, a thermally insulating interior material lining the exterior material, and a transparent front wall. The flap is waterproof and at least partially thermally insulated, and the flap is configured to be moved between a closed position in which the flap covers the front wall and an open position in which the flap does not cover the front wall such that the electronic device can be at least one of viewed and operated through the front wall.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated embodiments may be incorporated into any of the above-described aspects, alone or in any combination.

### BRIEF DESCRIPTION OF THE DRAWINGS

FIG. 1 is a perspective view of a case with a flap in a closed position and a mobile telephone housed therein;

FIG. 2 is a perspective view of the case of FIG. 1 with the flap in an open position;

FIG. 3 is a front view of the case of FIG. 1;

FIG. 4 is a sectional view of the case of FIG. 3 taken along the plane of line 4-4;

FIG. 5 is a section view of the case of FIG. 3 taken along the plane of line 4-4 when the flap is in the open position of FIG. 2; and

FIG. 6 is an enlarged portion of the case of FIG. 5.

Corresponding reference characters indicate corresponding parts throughout the several views of the drawings.

### DETAILED DESCRIPTION

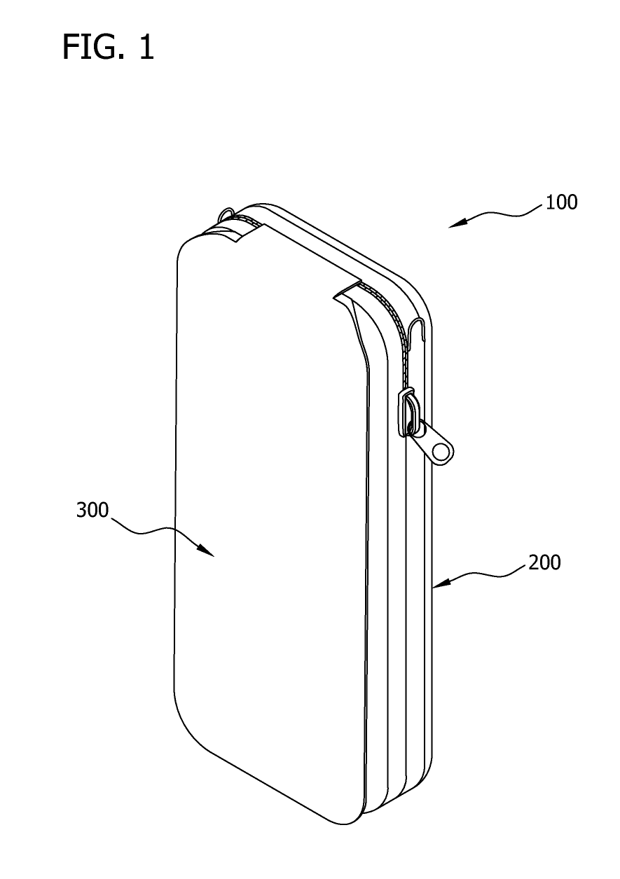

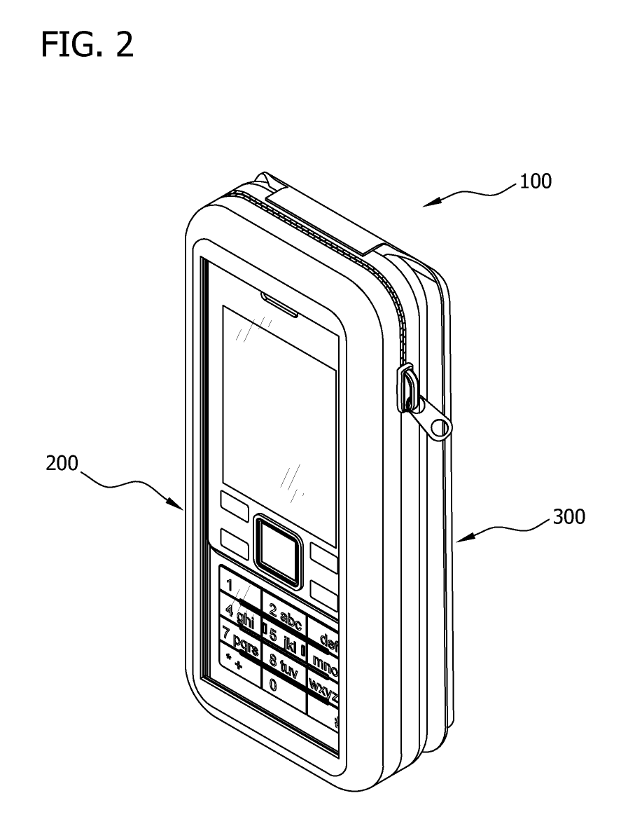

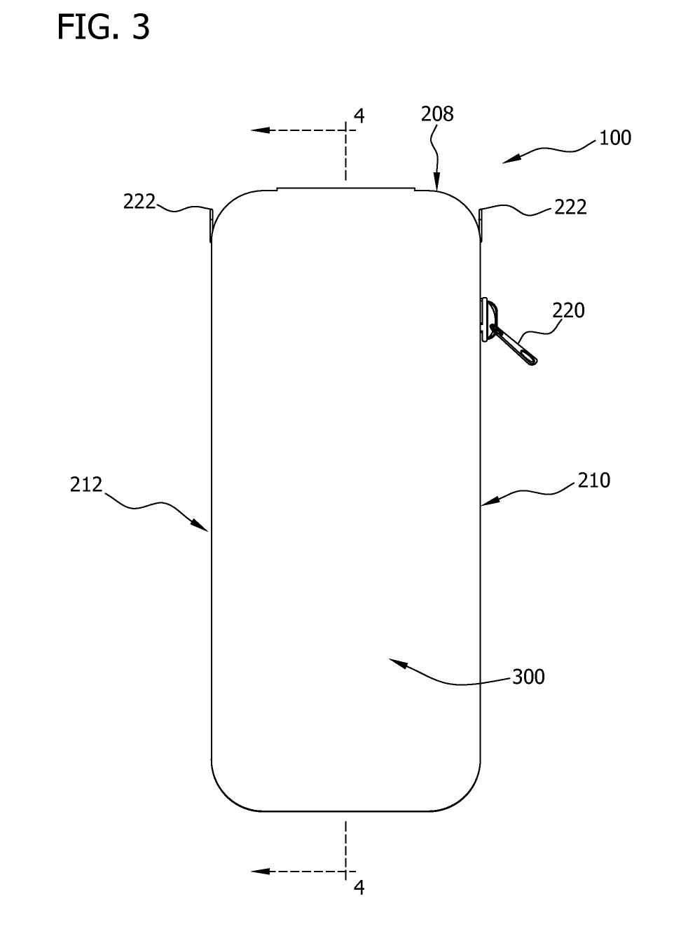

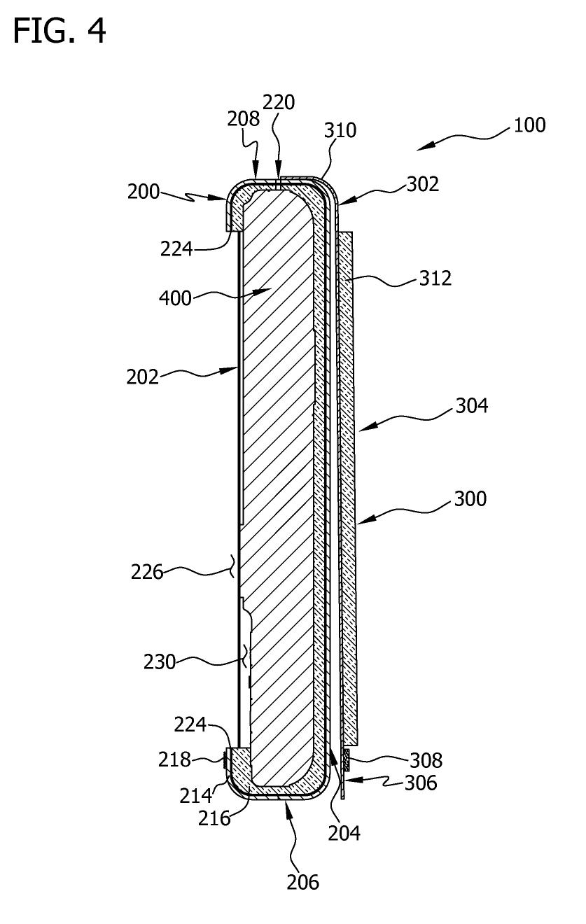

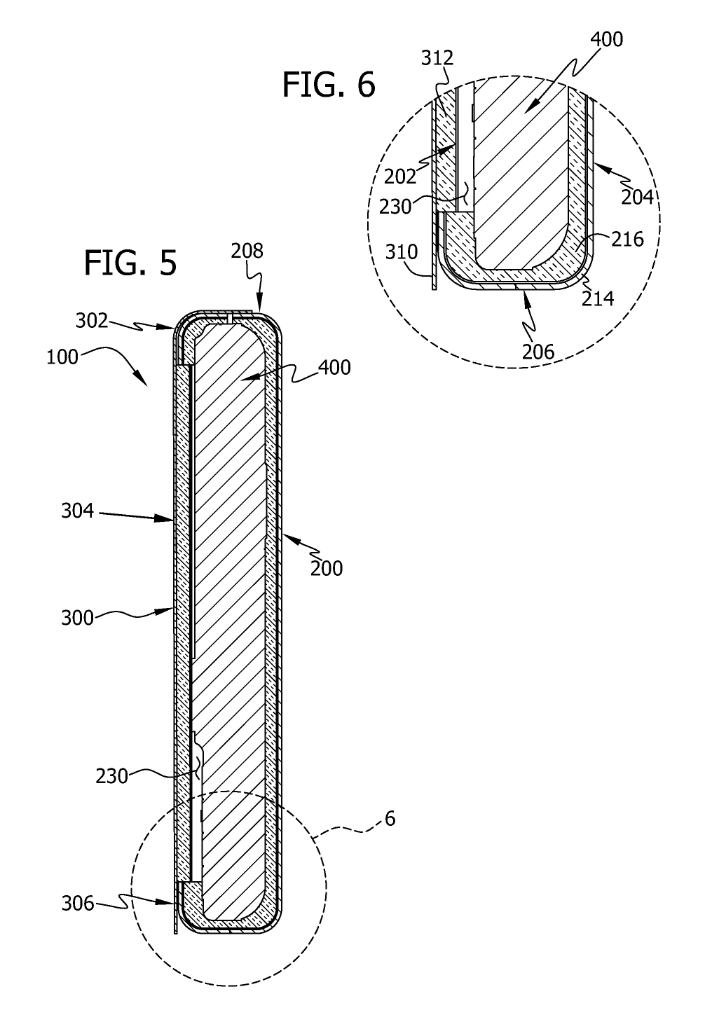

Referring now to the drawings, a case for a portable electronic device according to one embodiment is indicated by the reference numeral 100. The illustrated case 100 comprises a body 200 and a flap 300 connected to the body 200. The flap 300 has a “closed” position (FIGS. 1, 3, 5, and 6) (i.e., a position in which the flap 300 is down such that a portable electronic device housed therein is not accessible for use) and an “open” position (FIGS. 2 and 4) (i.e., a position in which the flap 300 is up such that the portable electronic device is accessible for use). While the case 100 is illustrated herein as being configured for use with a mobile telephone 400, it is understood that the case 100 may be configured for use with other suitable portable electronic devices and remain within the scope of this invention.

The body 200 includes a front wall 202, a back wall 204, a bottom wall 206, a top wall 208, a first side wall 210, and a second side wall 212 that define an interior space 230 sized to receive the mobile telephone 400. The back wall 204, the top wall 208, the bottom wall 206, and the first and second side walls 210, 212 have an exterior material 214 and an interior material 216 lining the exterior material 214. In the illustrated embodiment, the exterior material 214 is a flexible, waterproof, breathable material (e.g., a polytetrafluoroethylene (PTFE) material, such as a fabric sold under the trademark “Gore-Tex”), and the interior material 216 is a thermally insulating material (e.g., a down insulation or a synthetic fiber insulation, such as a polar fleece material or a material sold under the trademark “Thinsulate”). In one embodiment, the interior material 216 has a thickness of between about ¼″ and ½″. In another embodiment, the interior material 216 has a thickness of about ⅜″. In other embodiments, the interior material 216 may have any suitable thickness that enables the case 100 to function as described herein. Alternatively, the exterior material 214 may not be flexible and/or may not be breathable (e.g., the exterior material 214 may be a nylon material, a leather material, a vinyl material, a hard plastic material, or a rigid, rubber material). As used herein, the term “waterproof” refers to a material that does not permit passage of a liquid therethrough (i.e., a material that can be submerged in a liquid without passage of the liquid therethrough).

The bottom wall 206 includes a suitable first fastening device 218 (e.g., buckle, a snap, or a plurality of hooks or loops of a hook-and-loop fastener) for securing the flap 300 in the closed position. The top wall 208 has a closable aperture (e.g., a zipper 220) for easy insertion and/or removal of the mobile telephone 400 from the case 100. Because the exterior material 214 is flexible, a user can easily pull apart the body 200 at the aperture when the zipper 220 is open in order to insert the mobile telephone 400 into, or remove the mobile telephone 400 from, the interior space 230. In some embodiments, the zipper 220 is configured to seal the aperture in a watertight fashion to prevent water from entering the interior space 230 when the mobile telephone 400 is housed within the case 100. In other embodiments, the aperture may be located on any suitable wall of the case 100 (e.g., on one of the side walls 210, 212 or on the bottom wall 206) and may have any suitable mechanism for reclosing the aperture.

In the illustrated embodiment, a metal clip 222 is connected to each side wall 210, 212 proximate the top wall 208 to enable attachment of a strap to the case 100 (e.g., attachment of a strap that enables the user to carry the case 100 via his/her shoulder). The clips 222 are spaced apart so as to not interfere with the flap 300 when the flap 300 is moved between the closed position and the open position, as described in more detail below. It is understood that the case 100 may be configured with any suitable carrying mechanism that facilitates more easily carrying the case 100 (e.g., a plastic belt clip).

The front wall 202 is suitably connected (e.g., via a sewn connection or an adhesive connection) to the exterior material 214 and/or the interior material 216 at the top wall 208, the bottom wall 206, and the side walls 210, 212 to form a watertight seal that prevents water from entering the interior space 230. The front wall 202 is set back from the exterior material 214 to form a lip 224 that defines a recess 226 in the body 200. In alternative embodiments, the front wall 202 may not be set back from the exterior material 214 (e.g., the front wall 202 may be flush with the exterior material 214). In the illustrated embodiment, the front wall 202 is fabricated from a relatively thin, waterproof material that is substantially transparent (e.g., a PTFE material) to enable a user to view and/or operate the device (i.e., operate an interface of the mobile telephone 400 by punching a key pad and/or viewing a graphical user interface of the mobile telephone 400 through the front wall 202). In some embodiments, the front wall 202 may be fabricated from a material that enables a user to operate a touch-sensitive graphical user interface of the mobile telephone 400 (e.g., the front wall 202 may be fabricated from a thin plastic film that facilitates a predetermined amount of heat transfer therethrough to enable operation of the touch-sensitive graphical user interface using a finger).

The illustrated flap 300 includes an upper segment 302, an intermediate segment 304, and a lower segment 306. The flap 300 is connected to the top wall 208 (e.g., via a sewn attachment or an adhesive attachment) such that the flap 300 can be moved between the closed position and the open position. The lower segment 306 of the flap 300 includes a suitable second fastening device 308 (e.g., buckle, a snap, or a plurality of hooks or loops of a hook-and-loop fastener) that is configured to engage the first fastening device 218 of the body 200 to detachably secure the flap 300 in the closed position. In other embodiments, the body 200 and/or the flap 300 may have any suitable fastening device(s) located on any suitable portion of the body 200 and/or the flap 300 to enable the flap 300 to be opened/closed as desired. Alternatively, the case 100 may not include the flap 300 but, rather, may completely enclose the mobile telephone 400 such that the user must remove the mobile telephone 400 from the case 100 to use the mobile telephone 400.

The upper, lower, and intermediate segments 302, 304, 306 have an exterior material 310 that is waterproof and may be flexible and/or breathable (e.g., the exterior material 310 of the flap 300 is the same as the exterior material 214 of the body 200, as described above). However, unlike the body 200, only the intermediate segment 304 of the exterior material 310 is lined with a thermally insulating interior material 312. In the illustrated embodiment, the thermally insulating interior material 312 of the flap 300 is the same as the thermally insulating interior material 216 of the body 200, and the material 312 is sized to fit within the recess 226 of the body 200 (e.g., is sized with dimensions that are similar to those of the recess 226 such as, for example, sized with a thickness that is the same as the thickness of the interior material 216), as described in more detail below. In other embodiments, the entire exterior material 310 of the flap 300 (e.g., the upper segment 302, the intermediate segment 304, and the lower segment 306) may be lined with the thermally insulating interior material 312. Alternatively, any suitable portion of the exterior material 310 may be lined with the interior material 312 such that the case 100 functions as described herein.

In the open position, the flap 300 does not cover the zipper 220 (i.e., does not inhibit a user from inserting or removing the mobile telephone 400 from the case 100 via the zipper 220). In the closed position, the upper segment 302 of the flap 300 overlaps at least a portion of the zipper 220, thereby providing additional protection against liquid entering the aperture and against accidental removal of the mobile telephone 400 from the case 100 (e.g., in the event that the user forgets to zip the zipper 220 yet remembers to close the flap 300). Additionally, when the flap 300 is in the closed position, the interior material 312 contacts the lip 224 and the front wall 202 of the body 200 to provide a thermal seal of the recess 226 and prevent heat transfer through the front wall 202.

Accordingly, when an electronic device, such as the mobile telephone 400, is housed within the above-described case 100 and is subjected to cold temperatures (e.g., when the mobile telephone 400 is housed within the case 100 and is left in a car or carried on an outdoor excursion during the winter months), the case 100 inhibits adverse functional and/or structural affects of the cold on the mobile telephone 400 (e.g., the case 100 inhibits the user interface from freezing, inhibits the battery from losing its charge, and/or inhibits moisture from building up on the mobile telephone's circuitry). Additionally, when an electronic device, such as the mobile telephone 400, is housed within the above-described case 100 and is carried into a wet environment (e.g., outside in the rain or on a fishing trip), the case 100 inhibits the mobile telephone 400 from being exposed to moisture, thereby inhibiting the adverse affects that moisture can have on the function and/or structure of the mobile telephone 400.

When introducing elements of the present invention or the embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions without departing from the scope of the invention, it is intended that all matter contained in the above description and shown in the accompanying drawing[s] shall be interpreted as illustrative and not in a limiting sense.

What is claimed is:

1. A case for a mobile telephone, the case comprising:
a waterproof exterior material; and
a thermally insulating interior lining disposed inside the exterior material, the lining defining a closable interior space in which the telephone can be housed.

2. The case set forth in claim 1 wherein the exterior material is at least in part breathable.

3. The case set forth in claim 1 further comprising a zipper for closing the case.

4. The case set forth in claim 3 wherein the case comprises an upper wall, the zipper disposed on the upper wall.

5. The case set forth in claim 1 further comprising a pair of clips configured for attaching a shoulder strap to the case.

6. The case set forth in claim 5 wherein the case comprises an upper wall and a pair of opposing side walls adjacent the upper wall, the clips disposed on the side walls proximate the upper wall.

7. A case for a mobile telephone, the case comprising:
a waterproof body including a transparent front wall, the body defining a closable interior space in which the mobile telephone can be enclosed; and
a flap connected to the body, the flap configured to be moved between a closed position in which the flap covers the front wall and an open position in which the flap does not cover the front wall such that the mobile telephone can be at least one of viewed and operated through the front wall.

8. The case set forth in claim 7 wherein the waterproof body is at least in part breathable.

9. The case set forth in claim 7 wherein the waterproof body comprises a zipper for closing the interior space.

10. The case set forth in claim 9 wherein the waterproof body comprises an upper wall, the zipper disposed on the upper wall.

11. The case set forth in claim 7 wherein the waterproof body comprises a pair of clips configured for attaching a shoulder strap to the case.

12. The case set forth in claim 11 wherein the waterproof body comprises an upper wall and a pair of side walls adjacent the upper wall, the clips disposed on the side walls proximate the upper wall.

13. The case set forth in claim 7 wherein the flap is configured to be detachably fastened in the closed position.

14. A case for a mobile telephone, the case comprising:
a body comprising:
a waterproof exterior material;
a thermally insulating interior material lining the exterior material; and
a transparent front wall; and
a waterproof and at least partially thermally insulated flap connected to the body, the flap configured to be moved between a closed position in which the flap covers the front wall and an open position in which the flap does not cover the front wall such that the mobile telephone can be at least one of viewed and operated through the front wall.

15. The case set forth in claim 14 wherein the exterior material is at least partially breathable.

16. The case set forth in claim 14 wherein the body comprises a zipper for closing the interior space.

17. The case set forth in claim 16 wherein the body comprises an upper wall, the zipper disposed on the upper wall.

18. The case set forth in claim 14 wherein the body comprises a pair of clips configured for attaching a shoulder strap to the case.

19. The case set forth in claim 14 wherein the interior material is a synthetic fiber material.

20. The case set forth in claim 14 wherein the exterior material is at least one of a nylon material, a leather material, and a vinyl material.
